(19) United States
(12) Patent Application Publication
(10) Pub. No.: US 2002/0106131 A1
(43) Pub. Date: Aug. 8, 2002

(54) Apparatus and method for encoding image data

(75) Inventor: Minoru Suzuki, Yokohama-shi (JP)

Correspondence Address: Johnny A. Kumar, FOLEY & LARDNER, 3000 K Street, N.W., Suite 500, P.O. Box 25696, Washington, DC, 20007-8696, US

(73) Assignee: TOSHIBA TEC KABUSHIKI KAISHA

(21) Appl. No.: 09/773,533

(22) Filed: Feb. 2, 2001

(51) Int. Cl. G06K 9/36; G06K 9/46

(52) U.S. Cl. 382/244

(57) ABSTRACT

The present invention relates to an apparatus and a method for encoding image data which compresses image data by a combination of one-dimensional encoding and two-dimensional encoding for a plurality of lines. The apparatus is provided with a code start line selection section which changes an encoding start line position within a range of a processing unit defined by the combination of the one-dimensional encoding and the two-dimensional encoding, an encoding section which performs encoding for each processing unit from the encoding start line position, an encoding capacity determination section which determines an encoding efficiency on the basis of the result obtained by changing the encoding start line position, and an encoding control section which selects an encoding start line position at which the maximum encoding efficiency can be achieved from the determination result of the encoding efficiency. The method is performed by this configuration.

### BACKGROUND OF THE INVENTION

The present invention relates to an apparatus and a method for encoding image data where compression ratio of image data can be optimized. Regarding the apparatus for encoding image data, there have been conventionally various techniques.

FIG. 1 shows a configuration of a conventional image data encoding apparatus, which will be explained below.

As shown in FIG. 1, image data from a scanner section or the like is stored in a page data storage section 101. The image data which has been stored in the page data storage section 101 is read out by a page data reading-out section 102 to be input into a Huffman encoding section 103. In the Huffman encoding section 103, MR encoding is performed on the image data. The image data which has been subjected to the MR encoding is stored in a code data storage section 104, and the encoded data is sent to a modem or the like. An encoding control section 105 controls the page data reading-out section 102 and the Huffman encoding section 103 on the basis of setting performed by a main CPU.

Here, the MR encoding system intends to improve encoding efficiency by utilizing correlation between adjacent lines on the basis of MH encoding. That is, in the MR encoding system, MH encoding system is applied to each first line in every K lines (hereinafter, referred to as K parameter) and a two-dimensional encoding is performed on the second line to K-th line referring to data of the previous line.

Besides, in Jpn. Pat. Appln. KOKAI Publication No. 5-110737, there has been disclosed a technique where image information in one page is divided to a plurality of kinds of blocks such as a character, a photograph, or the like and the respective blocks are encoded by encoding methods suitable therefor.

Also, in Jpn. Pat. Appln. KOKAI Publication No. 6-169404, there has been disclosed a technique where an encoding system optimal for a document is obtained by calculation at a time of facsimile transmission and image data is transmitted by an encoding system with the highest compression rate.

Furthermore, in Jpn. Pat. Appln. KOKAI Publication No. 2000-224427, there has been disclosed a technique where image which has been divided into blocks, each including a plurality of lines, is compressed by a plurality of kinds of encoding modes and an encoding mode which minimizes data amount is determined from the compression result.

However, like the MR encoding, in a system where, regarding 4 lines (or 2 lines (=K parameter)), encoding is performed for each block comprising a combination of one-dimensional encoding for one line+two-dimensional encoding for three lines, the encoding has been always started at a constant position regardless of the fact that an encoding efficiency is changed according to difference in position of a boundary of the block for 4 lines relative to a document image at a time of encoding.

Therefore, there is a drawback that the position of the block boundary is not an optimal position for encoding necessarily so that optimization of encoding efficiency can not be achieved.

### BRIEF SUMMARY OF THE INVENTION

An object of the present invention is to determine a start line position for MR encoding with the optimal compression efficiency to employ the encoding data, thereby improving the compression efficiency and shortening a communication time. Furthermore, another object of the present invention is to perform deletion of the first line only at a time of a white line, thereby achieving a high efficient encoding without any influence on image content, and to add the deleted line to a final end of a page, thereby allowing a high efficient encoding without changing the number of the total lines on the page.

In order to achieve the above objects, according to a first aspect of the present invention, there is provided an apparatus for encoding image data which compresses image data by a combination of one-dimensional encoding and two-dimensional encoding for a plurality of lines, comprising: a encoding start line selection section which changes a encoding starts line position within a range of a processing unit defined by the combination of the one-dimensional encoding and the two-dimensional encoding; an encoding section which performs encoding for each processing unit from the encoding start line position; an encoding capacity determination section which determines an encoding efficiency on the basis of the result obtained by changing the encoding start line position; and an encoding control section which selects a encoding start line position at which the maximum encoding efficiency can be achieved from the determination result of the encoding efficiency.

According to a second aspect of the invention, there is provided an apparatus for encoding image data which compresses image data by a combination of one-dimensional encoding and two-dimensional encoding for a plurality of lines, comprising: a encoding start line selection section which changes an encoding start line position within a range of a processing unit defined by the combination of the one-dimensional encoding and the two-dimensional encoding; an encoding section which performs encoding for each processing unit from the encoding start line position; an encoding capacity determination section which determines an encoding efficiency on the basis of the result obtained by changing the encoding start line position; an encoding control section which selects an encoding start line position at which the maximum encoding efficiency can be achieved from the determination result of the encoding efficiency; and a white line determination section which determines presence/absence of a white line within the range of a processing unit defined by the combination of the one-dimensional encoding and the two-dimensional encoding, wherein the encoding control section excepts the line which has been determined as the white line by the white line determination section from a target of the encoding start line position.

According to a third aspect of the invention, there is provided a method for encoding image data which compresses image data by a combination of one-dimensional encoding and two-dimensional encoding for a plurality of lines, comprising the steps of: changing an encoding start line position within a range of a processing unit defined by the combination of the one-dimensional encoding and the two-dimensional encoding; performing encoding from the encoding start line position for each processing unit; a step of determining an encoding efficiency on the basis of the result obtained by changing the encoding start line position; and selecting an encoding start line position at which the maximum encoding efficiency is achieved on the basis of the determination result of the encoding efficiency.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a configuration of an apparatus for encoding image data according to a conventional art;

FIG. 2 is a block diagram showing a configuration of an apparatus for encoding image data according to a first embodiment of the present invention;

FIG. 3 is a flowchart showing an operation of the apparatus for encoding image data according to the first embodiment of the invention;

FIG. 4 is a diagram for explaining a characterized operation of the apparatus for encoding image data according to the first embodiment of the invention;

FIG. 5 is a diagram for explaining a characterized operation of the apparatus for encoding image data according to the first embodiment of the invention;

FIG. 6 is a diagram for explaining a characterized operation of the apparatus for encoding image data according to the first embodiment of the invention;

FIG. 7 is a block diagram showing a configuration of an apparatus for encoding image data according to a second embodiment of the invention; and

FIG. 8 is a flowchart showing an operation of the apparatus for encoding image data according to the second embodiment of the invention.

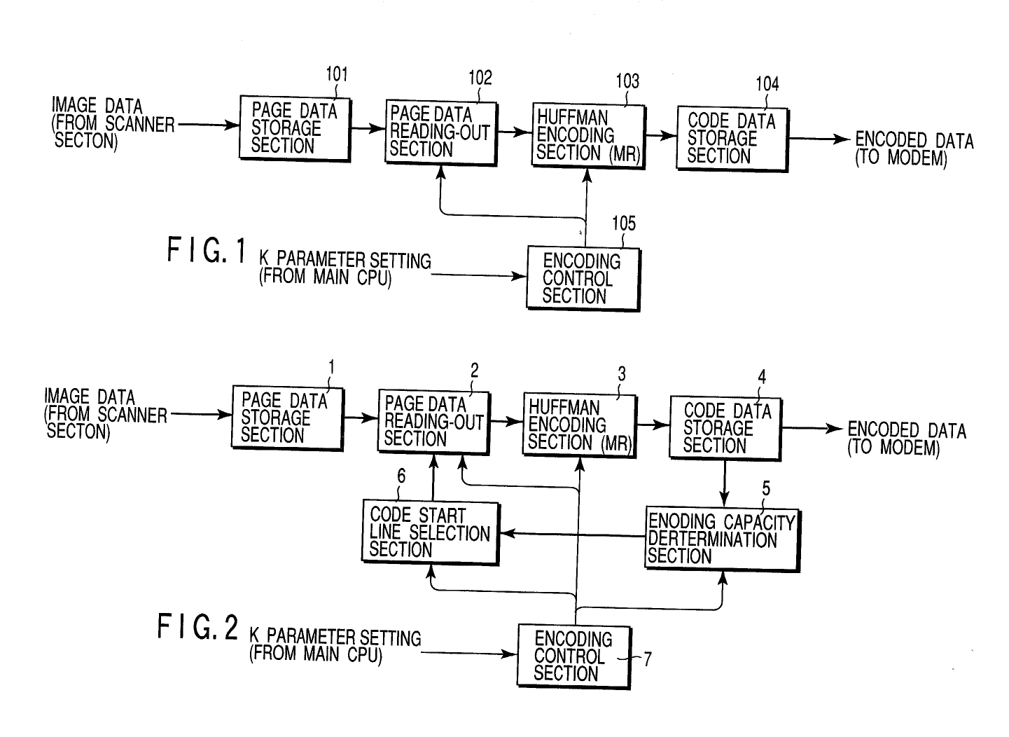

### DETAILED DESCRIPTION OF THE INVENTION

The present invention tries to perform encoding by shifting a line position from which MR encoding starts (encoding start line position) on an image in a document within a range of two-dimensional encoding lines (K parameter). As the result of the encoding, compressed data from which encoding starts, at which the maximum efficiency can be achieved is employed. Thereby, the present invention intends to attain optimization of the compression rate.

First of all, a first embodiment of the present invention will be explained.

FIG. 2 is a block diagram showing a configuration of an apparatus for encoding image data according to the first embodiment of the present invention. Configuration and operation of the embodiment will be explained below.

In FIG. 2, an output of a page data storage section 1 receiving an input of image data is connected to an input of a page data reading-out section 2. An output of the page data reading-out section 2 is connected to an input of a Huffman encoding section 3.

An output of the Huffman encoding section 3 is connected to an input of a code data storage section 4. Then, an output of the encoded data storage section 4 is connected to an input of an encoding capacity determination section 5, and an output of the encoding capacity determination section 5 is connected to an input of a code start line selection section 6. An output of the code start line selection section 6 is connected to an input of the page data reading-out section 2.

In addition, an output of an encoding control section 7 receiving setting of K parameter is connected to the inputs of the page data reading-out section 2, the Huffman encoding section 3, the encoding capacity determination section 5 and the code start line selection section 6.

In such a configuration, image data transmitted from an external scanner section or the like is stored in the page data storage section 1. The image data which has been stored in the page data storage section 1 is read out by the page data reading-out section 2 to be input into the Huffman encoding section 3. The Huffman encoding section 3 together with the page data reading-out section 2 performs MR encoding on the image data while shifting the encoding start line position line by line within a range of K parameter. Respective image data pieces which have been obtained by performing MR encoding at different encoding start line positions are stored in the code data storage section 4. Then, this encoded data is sent to an external modem section or the like. The encoding capacity determination section 5 determines an encoding efficiency for each encoding start line position on the basis of the image data which has been stored in the code data storage section 4. The code start line selection section 6 selects a start line position where the encoding efficiency is made optimal on the basis of the determination result about the encoding efficiency.

Incidentally, the encoding control section 7 controls the encoding capacity determination section 5 and the code start line selection section 6 on the basis of setting of K parameter performed by an external main CPU.

Here, the above MR encoding system is for improving an encoding efficiency by utilizing a correlation between adjacent lines on the basis of MH encoding. That is, in the MR encoding system, the MH encoding system is applied to the first line for every K lines and two-dimensional encoding is subsequently performed on the second line to the K-th line referring to data on the previous line.

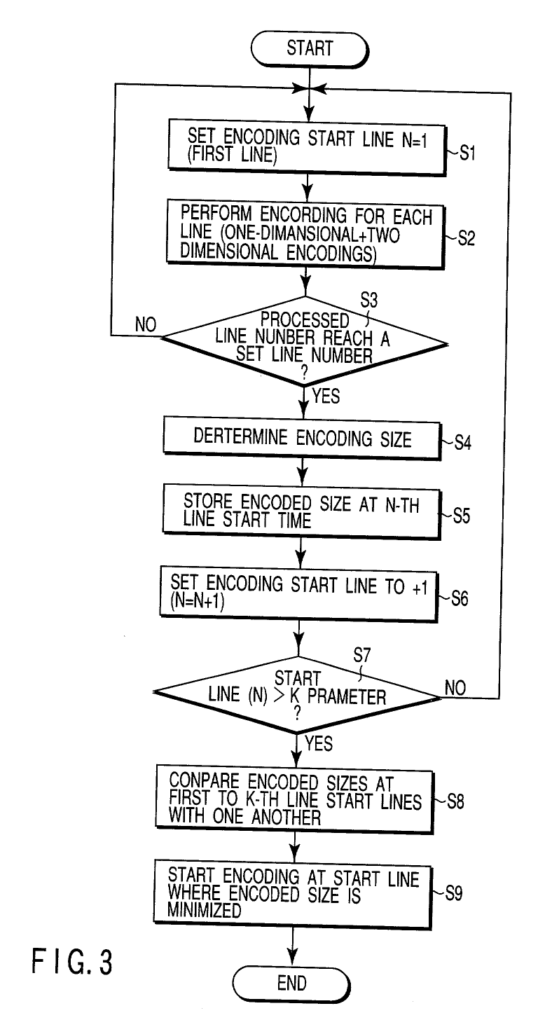

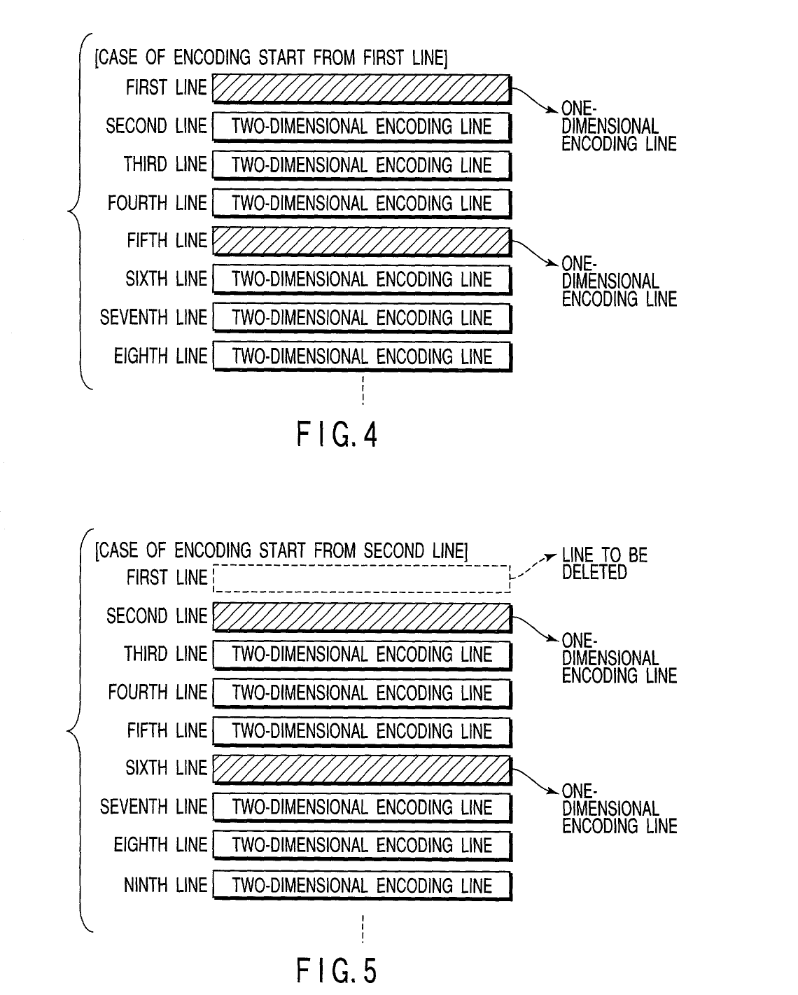

Operation of the apparatus for encoding image data according to the first embodiment will be explained below in detail with reference to a flowchart in FIG. 3.

Incidentally, this operation corresponds to a method for encoding image data of the present invention.

First of all, the encoding start line is set to the first line (n=1) by the encoding start line selections section 6 under the control of the encoding control section 7 (Step S1).

Next, MR encoding is performed from the start line for each line by the Huffman encoding section 3 (Step S2). The above processing is performed until the number of the processed lines reaches an arbitrarily and previously set number (Step S3). Incidentally, the image data obtained by this MR encoding is stored in the code data storage section 4.

Next, an encoded size is determined by the encoding capacity determination section 5 on the basis of the image data which has been stored in the code data storage section 4 (Step S4). At this time, the encoding capacity determination section 5 stores an encoded size obtained by setting the n-th line to the encoding start line therein (Step S5).

Then, the encoding start line selection section 6 shifts the encoding start line one by one (n=n+1) (Step S6). The operations from the above Steps S2 to S6 is repeated until the start line (n)>K parameter is met (Step S7).

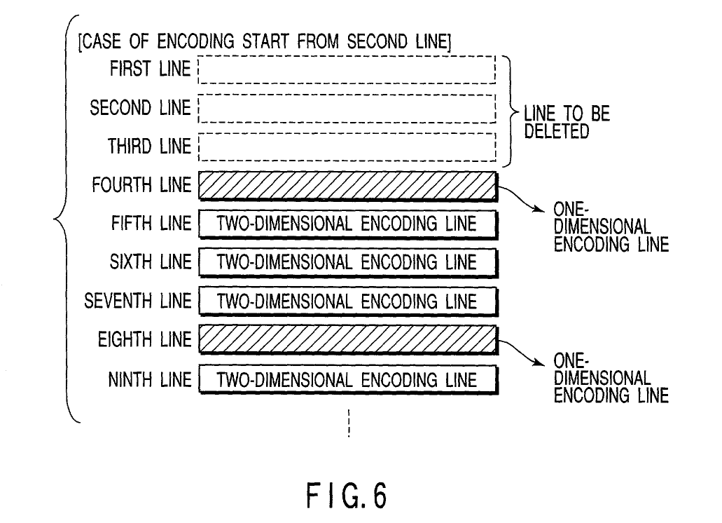

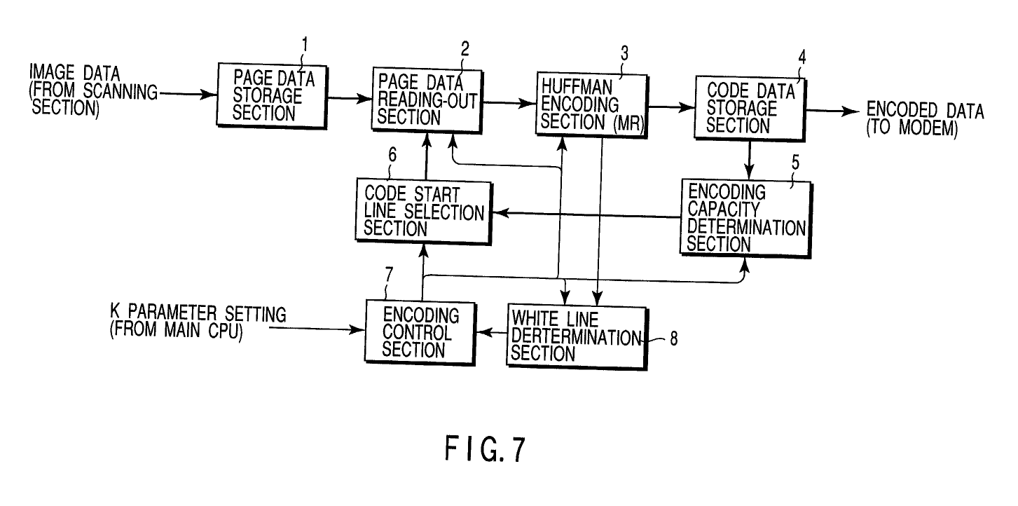

Here, the above operation will be explained more specifically with reference to FIG. 4 to FIG. 6. Incidentally, FIG. 4 shows a case where encoding has started from the first line, FIG. 5 shows a case where encoding starts from the second line, and FIG. 6 shows a case where encoding starts from the fourth line.

That is, when K parameter is set to “4”, as shown in FIG. 4, the first line is set as an encoding start line, one-dimensional encoding is performed on the first line, and two-dimensional encoding is performed on the second to fourth lines with reference to the result of the one-dimensional encoding. Thereafter, a similar processing is performed up to the final line on a document (Steps S2 to S7; the first cycle).

Next, as shown in FIG. 5, the second line is set as the encoding start line and the first line is handled as a line to be deleted. Then, one-dimensional encoding is performed on the second line, and two-dimensional encoding is performed on the third line to fifth line with reference to the result of the one-dimensional encoding. Thereafter, a processing similar to this is performed up to the final line on a document (Steps S2 to S7; the second cycle).

Since the third cycle is performed in the same manner as the second cycle, explanation thereof will be omitted.

As shown in FIG. 6, finally, the fourth line is set as the encoding start line, and the first line to the third line are handled as lines to be deleted. Then, one-dimensional encoding is performed on the fourth line, and two-dimensional encoding is performed on the fifth lines to the seventh lines with reference to the result of the one-dimensional encoding. Thereafter, a processing similar to the above is performed up to the final line on a document (Steps S2 to S7; the fourth cycle). In this manner, when a loop of the above Steps S2 to S7 is cycled four times, the control routine proceeds to Step S8 and the subsequent steps because K parameter is 4.

That is, thus, when start line (n)>K parameter is met, the encoded sizes at the start times of the first to the K-th lines are compared with one another (Step S8) by the encoding control section 7. Encoding starts in the start line at a time of encoded size minimum (Step S9). Thus, all the operations are completed.

In the above processing, for example, a trial for compression is performed by shifting MR encoding start line position on document data within a range of two-dimensional encoding line number (=K parameter) during facsimile transmission, a MR encoding start line where a compression efficiency is optimal (data amount is minimized) is determined from the result (data amount after compression), and the encoded data is employed so that a compression efficiency can be improved and a communication time can be reduced.

Next, a second embodiment of the present invention will be explained below.

FIG. 7 is a block diagram showing a configuration of an apparatus for encoding image data according to the second embodiment of the invention. As shown in FIG. 7, the apparatus for encoding image data according to the second embodiment is different from that of the first embodiment only in that the former is additionally provided with a white line determination section 8. The other configurations of the former are similar to those of the latter.

Here, it should be noted that the second embodiment has the following feature.

That is, the white line determination section 8 determines presence/absence of a white line within a range of K parameter. When it is recognized from this determination that there is a white line, the line to be determined is shifted to the next line, and the white line is handled as a line to be deleted.

Incidentally, by adding white lines of the same number as the number of the deleted lines to the final end of the document, a drawback due to the deletion can be solved.

In this embodiment, the determination on encoding is performed only on a white image within a range of lines of the number indicated by a range of a processing unit where a document leading is defined by a combination of one-dimensional encoding and two-dimensional encoding, but the present invention is not limited to this embodiment.

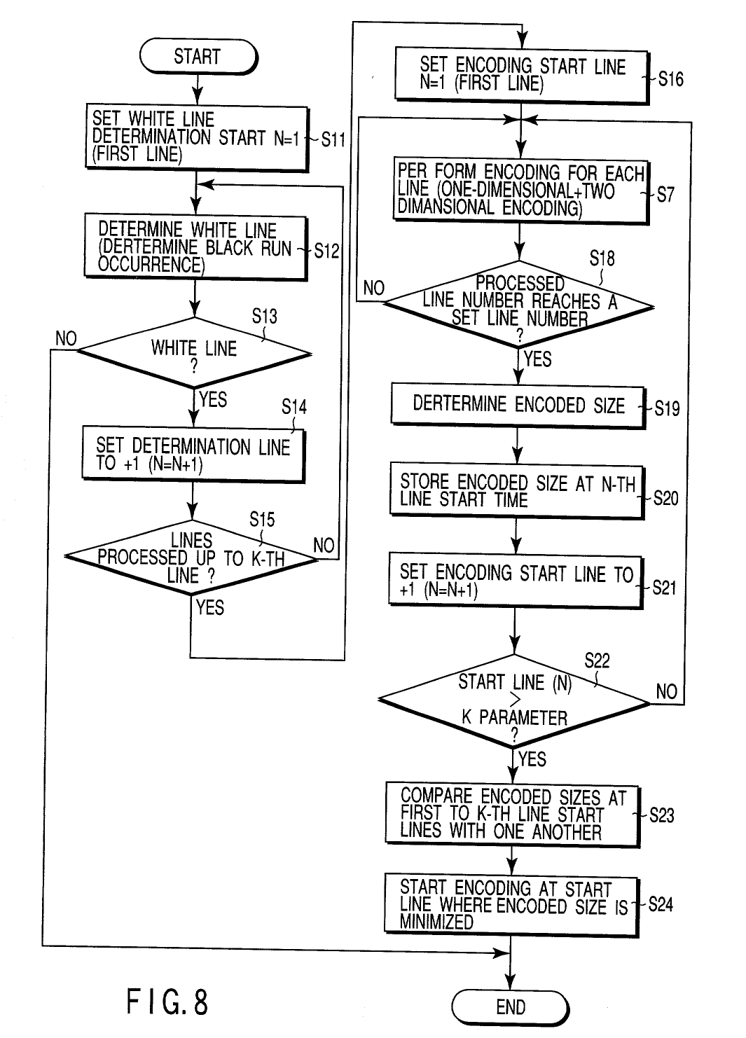

Operation of the apparatus for encoding image data according to the second embodiment will be explained below in detail with reference to a flowchart in FIG. 8.

Incidentally, this operation corresponds to a method for encoding image data.

First of all, for start of a white line determination, a start position is set to the first line (n=1) (Step S11). Subsequently, a white line determination is made by the white line determination section 8 (Step S12). This white line determination is made on the basis of the frequency of a black run in the corresponding line. A determination is made about whether or not the corresponding line is a white image on the basis of the determination result (Step S13).

Here, when it is determined that the line is not a white image, the operation is terminated.

On the other hand, when it is determined that the line is a white image, a line to be determined is set to the next line (n=n+1) (Step S14). Then, the operation of the Steps S12 to S14 is repeated within the range of K parameter (Step S15).

Thus, when the operation is performed up to the K-th line, an encoding start line is set to the first line (n=1) under the control of the encoding control section 7 by the encoding start line selection section 6 (Step S16).

Next, encoding is performed for each line by the Huffman encoding section 3 (Step S17). The above processing is performed until the number of the processed lines reaches a previously arbitrarily set number (Step S18). Incidentally, the encoded data which has been obtained by this encoding is stored in the code data storage section 4.

Thereafter, the encoded size is determined by the encoding capacity determination section 5 (Step S19). Then, the encoded size at the time of the n-th line start is stored in the encoding capacity determination section 5 (Step S20). The encoding start line selection section 6 increments the encoding start line (n=n+1) (Step S21).

Thus, the operation of the above Steps S2 to S6 is repeated until start line (n)>K parameter is met (Step S22).

When start line (n)>K parameter is met, the encoded sizes at the start times of the first to the K-th lines are compared with one anther by the encoding control section 7 (Step S23). Then, encoding starts from the start line at the encoding size minimum time (Step S24).

Thus, all the operation are terminated.

In the above processing, the MR encoding is made possible without any influence on the contents of an image by performing deletion of the first line only when it is determined that the first line is a white line. Also, the number of deleted lines is added to the final end of the page so that the MR encoding can be performed without changing the total number of lines in the page.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for encoding image data which compresses image data by a combination of one-dimensional encoding and two-dimensional encoding for a plurality of lines, comprising:
a encoding start line selection section which changes a encoding start line position within a range of a processing unit defined by the combination of the one-dimensional encoding and the two-dimensional encoding;
an encoding section which performs encoding for each processing unit from the encoding start line position;
an encoding capacity determination section which determines an encoding efficiency on the basis of the result obtained by changing the encoding start line position; and
an encoding control section which selects a encoding start line position at which the maximum encoding efficiency can be achieved from the determination result of the encoding efficiency.

2. An apparatus for encoding image data according to claim 1, wherein the encoding is a MR encoding, and the range of the processing unit defined by the combination of the one-dimensional encoding and the two-dimensional encoding is a range of K parameter.

3. An apparatus for encoding image data which compresses image data by a combination of one-dimensional encoding and two-dimensional encoding for a plurality of lines, comprising:
a encoding start line selection section which changes an encoding start line position within a range of a processing unit defined by the combination of the one-dimensional encoding and the two-dimensional encoding;
an encoding section which performs encoding for each processing unit from the encoding start line position;
an encoding capacity determination section which determines an encoding efficiency on the basis of the result obtained by changing the encoding start line position;
an encoding control section which selects an encoding start line position at which the maximum encoding efficiency is achieved from the determination result of the encoding efficiency; and
a white line determination section which determines presence/absence of a white line within the range of a processing unit defined by the combination of the one-dimensional encoding and the two-dimensional encoding;
wherein the encoding control section excepts the line which has been determined as the white line by the white line determination section from a target of the encoding start line position.

4. An apparatus for encoding image data according to claim 3, wherein the determination on the white line is made on the basis of the frequency of occurrence of a black pixel in a line.

5. An apparatus for encoding image data according to claim 3, wherein when the exception from the target of the encoding start line position is performed, the encoding control section adds lines of the same number as the number of the deleted lines to a final end of the encoded data relating to the white line.

6. An apparatus for encoding image data according to claim 3, wherein the determination about presence/absence of a white line made by the white line determination section is made within the range of a processing unit defined by the combination of the one-dimensional encoding and the two-dimensional encoding.

7. An apparatus for encoding image data according to claim 3, wherein, only when the white line determination section determines that there is a white line, the encoding start line position at which the maximum encoding efficiency is achieved is selected by the encoding control section.

8. An apparatus for encoding image data according to claim 3, wherein
the encoding is a MR encoding, and
the range of the processing unit defined by the combination of the one-dimensional encoding and the two-dimensional encoding is a range of K parameter.

9. A method for encoding image data which compresses image data by a combination of one-dimensional encoding and two-dimensional encoding for a plurality of lines, comprising the steps of:
changing an encoding start line position within a range of a processing unit defined by the one-dimensional encoding and the two-dimensional encoding;
performing encoding from the encoding start line position for each processing unit;
determining an encoding efficiency on the basis of the result obtained by changing the encoding start line position; and
selecting an encoding start line position at which the maximum encoding efficiency can be achieved on the basis of the determination result of the encoding efficiency.

10. A method for encoding image data according to claim 9, wherein
the encoding is a MR encoding, and
the range of the processing unit defined by the combination of the one-dimensional encoding and the two-dimensional encoding is a range of K parameter.

11. A method for encoding image data according to claim 9, further comprising:
a step of determining presence/absence of a white line within a range of a processing unit defined by the one-dimensional encoding and the two-dimensional encoding,
wherein a line which has been determined as a white line in the presence/absence determination step is excepted from a target of the encoding start line position.

12. A method for encoding image data according to claim 11, wherein the determination on the white line is made on the basis of the frequency of occurrence of a black pixel in a line.

13. A method for encoding image data according to claim 11, wherein, when the exception from the target of the encoding start line position is performed, lines of the same number as the number of the deleted lines is added to a final end of the encoded data relating to the white line.

14. A method for encoding image data according to claim 11, wherein the determination about presence/absence of a white line made by the white line presence/absence determination step is made within the range of a processing unit defined by the combination of the one-dimensional encoding and the two-dimensional encoding.

15. A method for encoding image data according to claim 11, wherein only when the white line presence/absence determination step determines that there is a white line, the encoding start line position at which the maximum encoding efficiency can be achieved is selected by the encoding control section.

16. A method for encoding image data according to claim 11, wherein the range of the processing unit defined by the combination of the one-dimensional encoding and the two-dimensional encoding is a range of K parameter.
